(19) United States
(12) Patent Application Publication
(10) Pub. No.: US 2011/0069937 A1
(43) Pub. Date: Mar. 24, 2011

(54) Apparatus, system and method for identifying advertisements from a broadcast source and providing functionality relating to the same

(76) Inventor: Laura Toerner, Oak Park, IL (US)

(21) Appl. No.: 12/586,222

(22) Filed: Sep. 18, 2009

(51) Int. Cl. H04N 5/91; G10L 21/06; H04N 9/80; G10L 11/00

(52) U.S. Cl. 386/250; 704/270; 386/E05.003

(57) ABSTRACT

An apparatus, system and method identifies an advertisement. Specifically, a user utilizes a microphone, preferably on a portable electronic device, to record at least a segment of an advertisement transmitted on television, radio, the Internet or other broadcast and/or audio sources. The advertisement is analyzed and identified, and functionality is provided based on the analysis and identification of the advertisement.

### BACKGROUND OF THE INVENTION

The present invention generally relates to an apparatus, system and method for identifying an advertisement. Specifically, the present invention relates to an application, either software or hardware, for a portable electronic device, such as a mobile or wireless telephone, an iPhone™, an iPod™, Blackberry™ or other like electronic device. A user utilizes the device's microphone to record an advertisement from a broadcast source, such as television, radio, the Internet or other audio source. The advertisement, or at least a segment thereof, is analyzed and identified and functionality is provided based on the analysis and identification of the advertisement.

It is, of course, generally known to transmit information to users or listeners. Since the dawn of radio and television broadcast, people have tuned in to listen to content broadcast by a broadcast source. To keep broadcasting free to the listener, advertising has also been broadcast of goods, services and/or events from individuals and companies that pay the broadcasters for the transmission of the advertising.

As the ability to reach listeners has developed and changed, new and more sophisticated ways of reaching listeners have been developed. For example, while radio and television broadcasting were the easiest and best way to reach consumers for many years, the Internet provides many new ways to reach consumers. Moreover, there are now other ways technology is utilized to transmit audio content, including, for example, satellite radio, satellite television, movie theater, broadcast and tailored messages sent through SMS, VoIP, or other network broadcast services.

No matter the medium through which the message is played, however, advertising to entice listeners to purchase goods and services and inform listeners of events remains important to companies and individuals. Advertising plays an important role informing listeners of new products, services, and/or events.

Typically, advertising is designed to entice a listener to purchase a good and/or service, visit a retail location, take action on a particular matter, such as a political matter, and/or to otherwise inform a listener of an event. Advertisers do this by creating commercials that a listener may remember. However, many people lead very busy lives and many times may be interested in a product, service, or an event but have no ability to write down or record the information imparted by the advertising. The very nature of advertising broadcast or otherwise imparted through an audio source is transient; once played to a consumer, it is typically gone. In many cases, people simply forget the information provided in the advertisement, especially when a listener diverts his or her attention elsewhere.

Further, it is known to provide a database for holding recorded advertisements or other information relating to advertisements that are broadcast, whether advertisements appear on television, or are heard through the radio, the internet or other like broadcasting sources. For example, the companies DG Fastchannel, Slingspot, First Spin, Spot Genie, Filmcore and VMS each keeps a database of advertising media that is broadcast on television, radio, the Internet, at movie theaters, and on other like broadcasting sources. Typically, these companies receive advertisements and distribute the same to radio stations, television stations and the like for broadcast. Each keeps a database of advertisements that is typically searchable. Moreover, some organizations actively record advertisements that are broadcast over radio, television and other like broadcast sources. Specifically, for example, VMS records, via monitoring an array of broadcasting sources, a plurality of advertisements and stores the same in a database. The advertisements may be analyzed and information relating to the advertisements may be compiled.

Moreover, it is further known to record audible signals from broadcast sources to analyze and identify the same. Specifically, it is known to record a song or a segment thereof from a radio broadcast, analyze the recorded song or segment, and compare the recorded song or information relating thereto to a central database of songs to obtain information about the song. In some cases, the recorded song has an embedded artificial code or watermark that is read and identified, the embedded code leading to information about the song. In other cases, the song is analyzed and compared to a database of songs to match the song. Once identified, information about the song can be provided to the user.

For example, U.S. Patent Application No. US2007/0118375 to Kenyon et al., which is expressly incorporated herein by reference in its entirety, relates to a method and system for direct audio capture and identification of the captured audio, followed by an opportunity to purchase the recording directly over the Internet or similar outlet. The system describes one or more user-carried portable audio capture devices that employ a microphone, analog to digital converter, signal processor and memory to store samples of ambient audio or audio features calculated from the audio. Automatic pattern recognition techniques are used to identify the captured sample by comparing the captured sample to a library of recordings offered for sale.

Moreover, U.S. Pat. No. 7,328,153, which is expressly incorporated herein in its entirety, identifies copies of original sound recordings by extracting features from the copy, creating a vector of those features, and comparing that vector against a database of vectors of known sound recordings. Identification can be performed for copies of sound recordings that have been subjected to compression and other manipulation such that they are not exact replicas of the original.

In addition, U.S. Pat. No. 6,990,453 to Wang et al., which is expressly incorporated herein in its entirety, locates an audio file that most closely matches an audio sample from a database indexing a large set of original recordings. Each indexed audio file is represented in the database index by a set of landmark timepoints and associated fingerprints. To perform recognition, landmarks and fingerprints are computed for the unknown sample and used to retrieve matching fingerprints from the database.

Audio analysis to compute a “fingerprint” of the audio, or to identify an embedded artificial code or watermark, is particularly useful for identifying music one hears on the radio, and for providing information about the music to a listener. However, advertisements are not currently identified. Moreover, individuals are typically not primarily interested in obtaining a copy of the advertising, like they would a song heard on the radio. A listener is more likely to be interested in the information imparted by the advertising relating to the good, service, event, issue and/or other subject that is advertised. Moreover, if the advertisement relates to a good and/or service for purchase, a listener is more likely interested in the means to purchase the good and/or service.

Moreover, while it is known to provide means for purchasing a song recorded and identified, or even goods advertised in the advertisement, such as described in U.S. Patent Application No. US2008/0214236 to Harb, which is expressly incorporated herein in its entirety, other functionality associated with the advertising spot is not typically known or described.

A need, therefore, exists for an apparatus, system and method for providing a database of advertisements played on broadcast media, such as radio, television, the Internet or other like broadcasting sources. Moreover, a need exists for an apparatus, system and method for analyzing the database of advertisements.

In addition, a need exists for an apparatus, system and method for recording an advertisement or at least a segment thereof from radio, television, the Internet or other like broadcasting sources. Further, a need exists for an apparatus, system and method for analyzing the recorded advertisement or segment thereof and comparing it against a database of previously recorded advertisements to identify the recorded advertisement.

Moreover, a need exists for an apparatus, system and method for providing functionality based on the good, service, event and/or issue advertised in the advertisement. Specifically, a need exists for an apparatus, system and method for providing a notice to the user regarding the good, service, event and/or issue advertised in the advertisement.

Further, a need exists for an apparatus, system and method for accessing an electronic calendar of a user and automatically providing an entry to remind the user to obtain information about the good, product and/or event advertised in the advertisement. Still further, a need exists for an apparatus, system and method for accessing an electronic calendar of a user and automatically providing an entry on the date of an event advertised in the advertisement and/or providing reminders on dates and/or times prior to the date and/or time of the event.

In addition, a need exists for an apparatus, system and method for accessing a digital video recorder to set a recording of a television program or other broadcast event related to the content of the advertisement.

Further, a need exists for an apparatus, system and method that allow advertisements to be more accessible to consumers from advertisers.

Still further, a need exists for an apparatus, system and method that allow listeners and/or consumers to easily provide information to advertisers or to other like groups, such as political action committees for signing a petition, for example, purchase information relating to a good and/or service, recipes for foods, drinks and the like, directions to locations, or other like information.

### SUMMARY OF THE INVENTION

The present invention generally relates to an apparatus, system and method for identifying an advertisement. Specifically, the present invention relates to an application, either software or hardware, for a portable electronic device, such as a mobile or wireless telephone, an iPhone™, an iPod™, a Blackberry™ or other like electronic device. A user utilizes the device's microphone to record an advertisement broadcast or otherwise transmitted from an audio source, such as, for example, television, radio, the Internet or other media. The advertisement, or at least a segment thereof, is analyzed and identified, and functionality is provided based on the analysis and identification of the advertisement.

To this end, in an embodiment of the present invention, an apparatus for recording and identifying an advertisement is provided. The apparatus comprises a recording device for recording at least a segment of an advertisement from a broadcast source, the advertisement relating to a subject selected from the group consisting of a good, a service, an event, an issue or a combination thereof; an identification module wherein the identification module identifies the advertisement based on the recorded audio segment; and an electronic module for receiving a communication relating to the subject of the advertisement, wherein the electronic module is selected from the group consisting of an e-mail client, an electronic calendar and a digital video recorder.

In an embodiment, the recording device is associated with a portable electronic device.

In an embodiment, the identification module identifies the advertisement by having the audio segment compared to advertisements in a advertisement database.

In an embodiment, the identification module reads an embedded code in the audio segment to identify the audio segment.

In an embodiment, the communication comprises information about the subject of the advertisement.

In an embodiment, the communication creates an entry on the electronic calendar containing information about the subject of the advertisement.

In an embodiment, the subject of the advertisement relates to a televised event and further wherein the communication sets the digital video recorder to record the televised event.

In an alternate embodiment of the present invention, a system for recording and identifying an advertisement is provided. The system comprises an apparatus comprising a recording device for recording at least a segment of an advertisement from a broadcast medium, the advertisement relating to a subject selected from the group consisting of a good, a service, an event, an issue, or a combination thereof; an identification module wherein the identification module identifies the advertisement based on the recorded audio segment; an electronic module for receiving a communication relating to the subject of the advertisement, wherein the electronic module is selected from the group consisting of an e-mail client, an electronic calendar and a digital video recorder; and a database comprising information relating to a plurality of advertisements, wherein the recorded advertisement from the broadcast medium is identified by searching the database for identification characteristics of the plurality of advertisement.

In an embodiment, the recording device is associated with a portable electronic device.

In an embodiment, the recorded advertisement from the broadcast medium is identified by comparing the audio segment against a plurality of advertisements in the database.

In an embodiment, the database contains identification codes for a plurality of advertisements wherein the audio segment of the advertisement contains an embedded code, wherein the advertisement is identified by comparing the embedded code against the identification codes for the plurality of advertisements.

In an embodiment, the communication comprises information about the subject of the advertisement.

In an embodiment, the communication creates an entry on the electronic calendar containing information about the subject of the advertisement.

In an embodiment, the subject of the advertisement relates to a televised event wherein the communication sets the digital video recorder to record the televised event.

In an alternate embodiment of the present invention, a method of recording and identifying an advertisement is provided. The method comprising the steps of recording at least a segment of an advertisement from a broadcast medium, the advertisement relating to a subject selected from the group consisting of a good, a service, an event, an issue, or a combination thereof; identifying the advertisement based on the recorded segment of the advertisement; and receiving a communication relating to the subject of the advertisement, wherein the communication is received by an electronic module, the electronic module selected from the group consisting of an e-mail client, an electronic calendar, and a digital video recorder.

In an embodiment, the recording device is associated with a portable electronic device.

In an embodiment, the method further comprises the steps of providing a database containing a plurality of advertisements; and identifying the advertisement by comparing the audio segment to the plurality of advertisements in the database.

In an embodiment, the method further comprises the steps of reading an embedded code in the audio segment; providing a database comprising a plurality of identification codes related to a plurality of advertisements; and identifying the audio segment by comparing the embedded code against the plurality of codes contained in the database.

In an embodiment, the method further comprises the step of creating an entry on the electronic calendar containing information about the subject of the advertisement.

In an embodiment, the subject of the advertisement relates to a televised event. The method further comprises the step of setting the digital video recorder to record the televised event.

Therefore, it is an advantage of the present invention to provide an apparatus, system and method for providing a database of advertisements played on broadcast sources, such as radio, television, the Internet or other like broadcasting sources or audio sources.

Moreover, it is an advantage of the present invention to provide an apparatus, system and method for analyzing advertisements in the database of advertisements.

In addition, it is an advantage of the present invention to provide an apparatus, system and method for recording an advertisement or at least a segment thereof from radio, television, the Internet or other like broadcasting sources or audio sources.

Further, it is an advantage of the present invention to provide an apparatus, system and method for analyzing the advertisement and for comparing it against a database of previously recorded advertisements to identify the advertisement.

Moreover, it is an advantage of the present invention to provide an apparatus, system and method for providing functionality based on the good, service, event and/or issue advertised in the advertisement. Specifically, it is an advantage of the present invention to provide an apparatus, system and method for providing a notice to the user regarding the good, service, event and/or issue advertised in the advertisement.

Further, it is an advantage of the present invention to provide an apparatus, system and method for accessing an electronic calendar of a user and automatically creating an entry to remind the user to obtain information about the good, product and/or event advertised in the advertisement.

Still further, it is an advantage of the present invention to provide an apparatus, system and method for accessing an electronic calendar of a user and automatically creating an entry on the date of an event advertised in the advertisement and/or for creating reminders on dates and/or times prior to the date and/or time of the event.

In addition, it is an advantage of the present invention to provide an apparatus, system and method for accessing a digital video recorder to set a recording of a television program or other broadcast event related to the content of the advertisement.

Further, it is an advantage of the present invention to provide an apparatus, system and method that allow advertisements to be more accessible to consumers from advertisers.

Still further, it is an advantage of the present invention to provide an apparatus, system and method that allow listeners and/or consumers to easily provide information to advertisers or to other like groups, such as political action committees for signing a petition, for example, purchase information relating to a good and/or service, recipes for foods, drinks and the like, directions to locations, or other like information.

Additional features and advantages of the present invention are described in, and will be apparent from, the detailed description of the presently preferred embodiments and from the drawings.

### BRIEF DESCRIPTION OF THE DRAWINGS

FIG. 1 illustrates a system overview in an embodiment of the present invention.

FIG. 2 illustrates a functional block diagram in an embodiment of the present invention.

FIG. 3 illustrates a functional block diagram in an alternate embodiment of the present invention.

### DETAILED DESCRIPTION OF THE PRESENTLY PREFERRED EMBODIMENTS

The present invention generally relates to an apparatus, system and method for identifying advertisements. Specifically, the present invention relates to an application, either software or hardware, for a portable electronic device, such as a mobile or wireless telephone, an iPhone™, an iPod™, a Blackberry™ or other like electronic device. A user utilizes the device's microphone to record an advertisement broadcast on television, radio, the internet or other audio source. The advertisement is analyzed, identified, and functionality is provided based on the analysis and identification of the advertising.

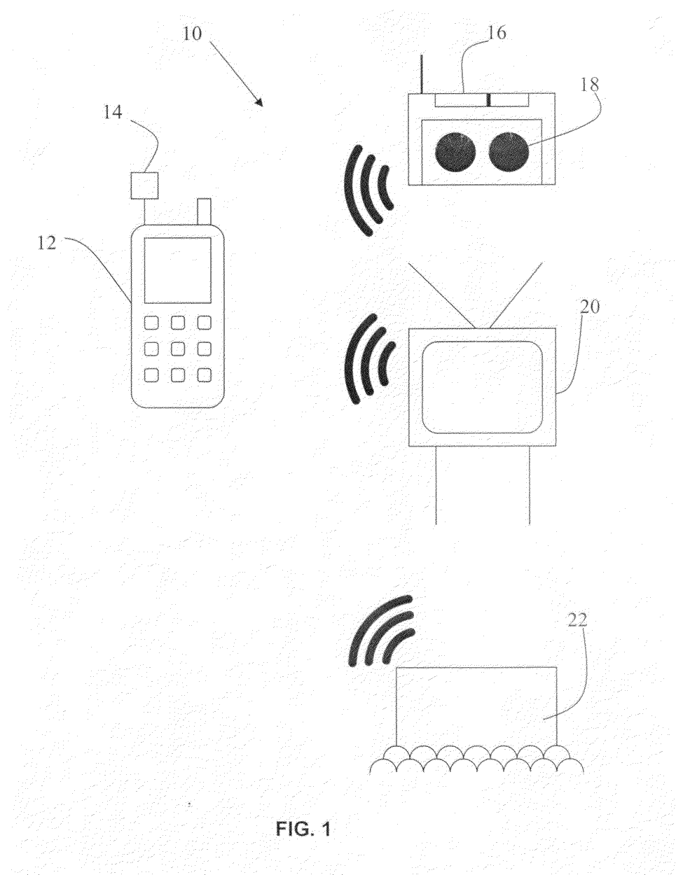

Now referring to the figures, wherein like numerals refer to like parts, a system 10 is disclosed. The system 10 comprises an electronic capture device 12 having a microphone 14. The microphone 14 receives an audio segment of an advertisement transmitted by a transmitting electronic device, represented in FIG. 1 as a radio 16 with a speaker 18, a television 20, or an audio speaker in a movie theater 22. Of course, the transmitting electronic device may be any electronic device sending an audible signal that may be detected and recorded by the electronic capture device 12.

The electronic capture device 12 may be a stand-alone device or may be contained within or otherwise embedded in other electronic devices. Specifically, the electronic capture device 12 may be a portable electronic device or contained within a portable electronic device, such as, for example, a wireless telephone, such as an iPhone™, a personal digital assistant (PDA) such as a Palm Pilot™, an iPod™ or any other type of portable electronic device. Alternatively, the electronic capture device 12 may be embedded within a radio, either portable or not, such as a car radio, a computer, whether laptop or desktop, or any other electronic device. Moreover, the electronic capture device 12 may be part of an automobile, and/or may be a component of a car radio, either terrestrial-based or satellite-based, or an on-board display system that may have wireless connectivity with the Internet. The electronic capture device 12 may consist of software and/or hardware, as apparent to one having ordinary skill in the art.

The microphone 14 may preferably be internal to the electronic capture device 12, although the invention should not be limited as described herein, as the microphone 14 may be an external microphone, as shown in FIG. 1. The microphone 14 receives audible signals from a broadcasting source, such as a transmitting electronic device.

As noted above, the transmitting electronic device may be a radio 16 having a speaker 18, a television 20, or a speaker in a movie theater 22. Other like electronic devices that transmit an audible signal include a computer (not shown), a loudspeaker, a concert speaker, and/or other like audio sources. The transmitting electronic device 16, 20, and/or 22 may transmit audible signals from sources including conventional broadcasting sources, satellite distribution feeds, the Internet, data distribution networks, or other like sources. The transmitting electronic device 16, 20 and/or 22 plays the audible signal or otherwise makes the audible signal audible through one or more speakers, whereby the audible signal may be received by the microphone 14 and recorded by the electronic capture device 12.

It should be noted that the electronic capture device 12 and the transmitting electronic device 16, 20 and/or 22 may be combined together into a single unit, as apparent to one having ordinary skill in the art. For example, a portable electronic device may receive radio waves for playing thereon. The portable electronic device may further include a microphone for recording the same. The audible signal may preferably be an advertisement.

The advertisement typically may include information about a good, a service, an event, an issue and/or other like information. Specifically, the advertisement may be spoken, may contain music, and/or other sounds to transmit information to a listener of the audible signal.

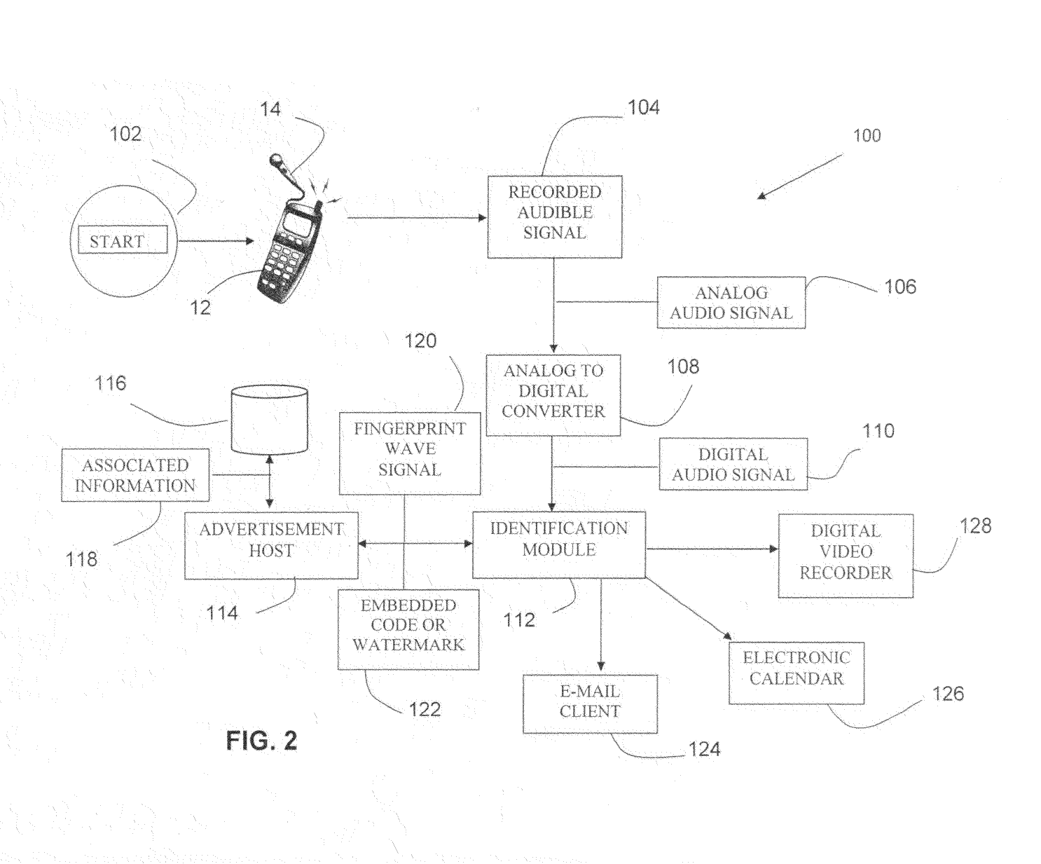

Referring now to FIG. 2, a system 100 illustrates how an audible signal of an advertisement may be recorded and identified. Further, FIG. 2 illustrates specific functionality with respect to information gleaned from identification of the advertisement.

Specifically, the system 100 may include the electronic capture device 12 and microphone 14. A user of the electronic capture device 12 may implement an application by pushing a “start” button 102. The “start” button 102 may be a physical button on the electronic capture device 12 or may be a virtual button on a touchscreen of the electronic capture device 12. Alternatively, the “start” button 102 may be “pushed” via voice detection instructions. Once the user activates the application by pressing or otherwise activating the “start” button 102, an audible signal of an advertisement may be received by the microphone and recorded by the electronic capture device 12, thereby generating a “recorded audible signal” 104. The “recorded audible signal” represents an analog audio signal 106 that may be a full advertisement or a segment or portion of an advertisement. The analog audio signal 106 may be digitized in an analog to digital converter 108 to create a digitized audio signal 110. The digitized audio signal 110 may be sent to an identification module 112.

The identification module 112 may be contained within the electronic capture device 12 or a separate component, such as a host computer or other electronic device. If the identification module 112 is within a separate component, the digitized audio signal 110 may be sent to the identification module 112 by direct wired or wireless connection of the electronic capture device 12 to the separate component, or through a network, such as the Internet or other like network.

The identification module 112 may communicate with an advertisement host 114 having a database 116 containing information relating to a plurality of advertisements transmitted over the broadcast sources.

Specifically, the advertisement host 114 may have or otherwise may receive digitized copies of advertisements that may be transmitted through the broadcast sources. For example, a plurality of companies and organizations may receive advertisements from advertisers, typically for distribution to radio stations, television stations and other like broadcast sources. These companies, including but not limited to, DG Fastchannel, Slingspot, Spottraffic, First Spin, Spot Genie, and Filmcore, typically store the advertisements. For example, DG Fastchannel's subsidiary SourceEcreative keeps a database of hundreds of thousands of advertisements wherein the advertisements are searchable, via visual style, keyword, genre, region of the world and/or talent that worked on it.

Alternatively, the advertisement host 114 may actively monitor broadcast sources and record copies of many if not all advertisements broadcast via broadcast sources. The advertisement host 114 may digitize the advertisements and store the same within the database 116. For example, VMS is an organization that monitors advertisements broadcast through radio, television and other broadcasting sources. Specifically, VMS records, through monitoring an array of broadcasting sources, a plurality of advertisements and stores the same in a database. The advertisements may be analyzed and information relating to the advertisements may be compiled.

In general, the database 116 may store the digitized copies of the advertisements received by the advertisement host 114. Analysis of the digitized copies of the advertisements may be conducted to provide a means to match corresponding information from the recorded audible signal 104.

Further, associated information 118 about the advertisements may also be received by the advertisement host 114 and may be associated with the advertisements stored in the database 116. The associated information 118 relating to the advertisements may include information about the goods, services, events and/or issues advertised. For example, if the advertisement relates to a good or service, the associated information 118 may include a description of the good and/or service, a source of the good and/or service, locations to purchase or obtain the good and/or service, a price for the good and/or service, discount information such as a coupon for the good and/or service and/or other like information. In an non-limiting example, if the good relates to a food having a recipe, the associated information 118 may include the recipe or information relating to whether to purchase ingredients and/or dishes need to prepare and/or cook the recipe.

If the advertisement relates to an event, the associated information 118 may include a description of the event, a location of the event, a date and time of the event, and other like information. If the advertisement relates to an issue, the associated information may include a description of the issue, and information relating to the issue. For example, if an issue is a political matter, the associated information may include information on where to obtain further information on the issue, how to sign a petition relating to the political matter, how to sign up to get involved on the political matter, or other like information.

Associated information 118 relating to the advertisements may further be generated and associated with the recorded advertisements that are stored in the database 116. Specifically, the advertisement host 114 may review the information provided in the advertisement and automatically create the associated information 118 relating to the advertisement, or the associated information 118 may be provided to the advertisement host 114 about the good, service, event and/or issue featured in the advertisement, as noted above.

The associated information 118 may be compiled by the advertisement host 114 and stored in the database 116. Alternatively, the associated information 118 may be divorced from the known recorded advertisements and stored in separated databases, but associated with the advertisement, such that identification of the advertisement allows for quick and easy retrieval of the associated information 118.

In a preferred embodiment of the present invention, the digital audio signal 110 is received by the identification module 112, processed and analyzed to determine a pattern or otherwise create a “fingerprint” wave signal 120 to be used for comparing against the known recorded advertisements contained within the database 116 at the advertisement host 114. While the present invention is described that the identification module 112 processes and analyzes the digital audio signal 110, this task may be performed by another module of hardware and/or software separate from the identification module 112, such as by the advertisement host 114 or other module, as apparent to one having ordinary skill in the art.

The fingerprint wave signal 120 may be generated as taught and disclosed in U.S. patent Application No. 2007/0118375 to Kenyon et al., expressly incorporated herein by reference in its entirety. However, the method described in Kenyon et al. is merely one way to generate a fingerprint wave signal 120 that may be utilized for identification of the advertisement recorded, and the invention should not be limited as described herein. Any other method of processing and analyzing the digital audio signal 110 may be utilized as apparent to one having ordinary skill in the art.

The fingerprint wave signal 120 of the recorded advertisement may be sent to the advertisement host 114 and compared against the known recorded advertisements contained within the database 116. A closest match of the recorded advertisement may be determined by comparing the recorded advertisement to the advertisements stored within the database 116. Once the advertisement may be identified, a copy of the recorded advertisement and/or the associated information 118 linked with the particular advertisement identified may be sent back to the identification module 112. Alternatively, the copy of the recorded advertisement and/or the associated information 118 may be sent to a separate software and/or hardware module to present to the user, as apparent to one having ordinary skill in the art.

Alternatively, the advertisement recorded by the electronic capture device 12 may contain an embedded code or watermark 122 that may be identified by the identification module 112 when the digital audio signal 110 is analyzed. The embedded code or watermark 122 may be sent to the advertisement host 114. The advertisement host 114 may contain, within the database 116, a listing of known codes or watermarks that are associated with known advertisements that may be received from a source or recorded and determined by the advertisement host 114. Again, the associated information 118 relating to the advertisements may be associated with the advertisements such that identification of the advertisement via the embedded code or watermark 122 allows the associated information to be retrieved relating to the advertisement identified.

Regardless of how the advertisement is identified, through a fingerprint method or an embedded code or watermark, the associated information 118 may be sent back to the identification module 112, or other like application, module or device. The associated information 118 may be contained within fields that may be interpreted by the identification module 112, or other like application, module or device. The identification module may use the associated information 118 to provide specific functionality, as described below.

In a non-limiting embodiment, the associated information 118 received by the identification module 112, or other like application, module or device, may simply be contained in an e-mail message, SMS text message, html page, or other like communication that may be sent back to the user of the electronic capture device 12, or to another individual. Specifically, the e-mail message may be sent to an e-mail client 124 of the user or other individual. Alternatively, an html-based web-page may be created with the associated information contained thereon, and a link may be provided to the user or other individual to view the html page with the associated information thereon.

The associated information 118, containing description information about the good, service, event and/or issue, may then be received by the user or other individual, and may serve as a reminder to the user or other individual to pursue the good, service, event and/or issue described. Alternatively, a link may be provided to the user or other individual to obtain further information and/or to determine how to purchase the good and/or service, or obtain further information or, for example, tickets to the event. If the event is a television show, for example, the communication may simply remind the user or other individual to watch the television show or remind the user to set a recording device to record the television event.

In another non-limiting embodiment of the present invention, the associated information 118 may be utilized by the identification module 112 to send a communication or otherwise access a user's or other individual's electronic calendar to create an entry or to otherwise provide instructions to the electronic calendar 126 to create an entry on the electronic calendar. For example, an entry may be created on a date and/or time simply with information relating to the good, service, event and/or issue advertised. The entry in the electronic calendar 126 may serve as a reminder to the user or other individual to obtain further information about the good, service, event and/or issue detailed in the advertisement.

Alternatively, if the associated information has date and/or time-specific information, such as the end of a sale at a store, or the date and/or time of an event, such as, for example, a circus in town or other event, then the entry in the electronic calendar 126 may be related to the time-specific information. For example, if a sale will end on January 14^{th}, a calendar entry may be added to January 14^{th} in the electronic calendar 126 detailing information about the sale and that the sale ends on that day. In addition or alternatively, a calendar entry may be set on a date prior to the end of the event to provide notice to the user or other individual of the end of the event prior to the end of the event. In another example, an event advertised in the advertisement may relate to a televised show or event. A calendar entry may be generated either reminding a user or other individual to tune in to watch the show or event, or to otherwise record the show or event. The calendar entry may also be prior to the date and/or time of the televised show or event, or may be on the date and/or time of the televised show or event.

In another non-limiting embodiment of the present invention, the associated information 118 may be utilized by the identification module 112 or other like application, module or device, to send detailed information to a user's or other individual's digital video recorder 128 to set the digital video recorder 128 to record a televised show or event. For example, if the subject of the recorded advertisement is a televised show or event that will be broadcast on a television channel on a certain date and/or time, the identification module 112 or other like application, module or device, may access the digital video recorder 128 of the user or other individual and provide instructions to record the television show or event automatically, so that the user or other individual need not manually enter the recording information.

In another non-limiting example, the associated information 118 may be utilized to send a communication to a user or other individual via the user's or other individual's e-mail client 124 requesting instructions. The instructions may relate to whether the user or other individual desires to create an entry in the user's or other individual's electronic calendar 126 or whether the user or other individual desires to set the digital video recorder 128 to record a televised show or event. If the user or other individual desires the calendar entry or digital video recorder to be set, the user or other individual may simply click on a link in an e-mail communication that provides the affirmative instructions to the identification module 112 or other like application, module or device, to make the calendar entry or recording happen.

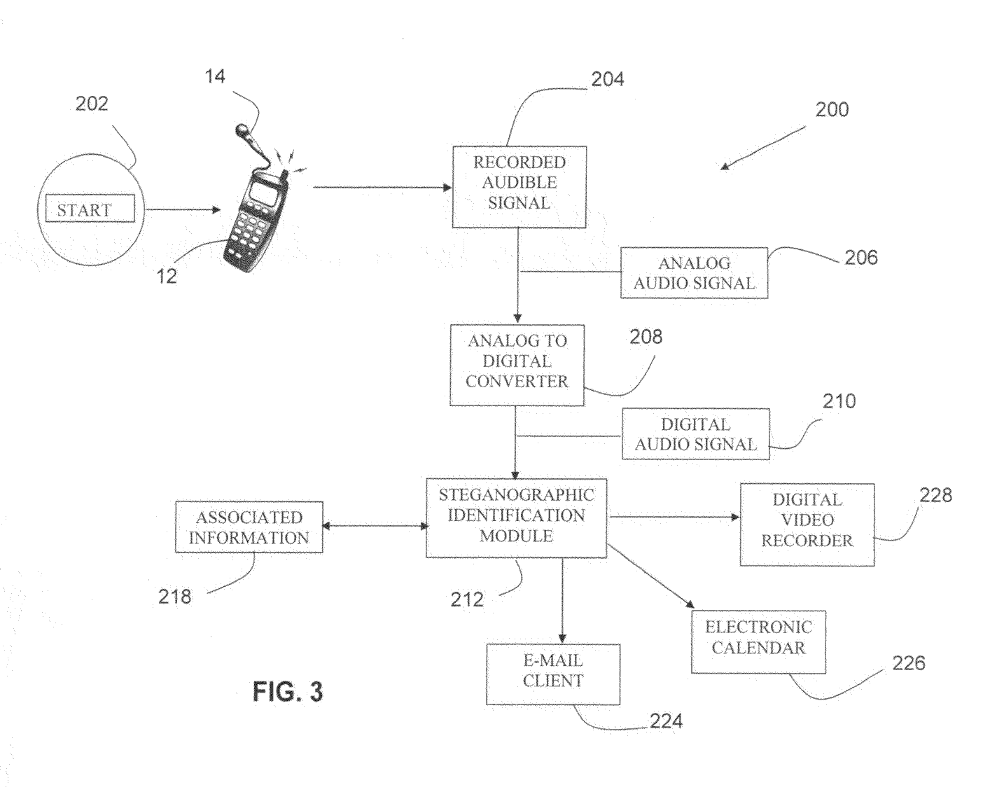

FIG. 3 illustrates a system 200 in an alternate non-limiting embodiment of the present invention. Specifically, a user may hear an advertisement broadcast via a broadcasting source and push a “start” button 202, whether physical, virtual or oral, to start recording at least a portion or segment of the advertisement on the electronic capture device 12 via the microphone 14 to create a recorded audible signal 204.

The recorded audible signal 204 may contain steganographic information relating to the good, service, event and/or issue detailed in the advertisement. Steganographic information is information that is present within the audible broadcast but hidden, much like the embedded code or watermark 122 detailed above with respect to FIG. 2. However, instead of merely providing an identification code for matching with a database of codes to identify the advertisement, the steganographic information provides the entirety of the associated information, or at least a portion of the associated information.

The recorded audible signal 204 may be analyzed by a steganographic identification module 206, whereby the steganographic information relating to the advertisement is decoded. Specifically, the steganographic information may include detailed information about the good, service, event and/or issue, including, for example, date and/or time information. The steganographic information may be compiled by the steganographic identification module to form associated information 208 that is utilized to create a communication to the e-mail client 224, the electronic calendar 226 and/or the digital video recorder 228. The associated information 208 may be utilized to allow the same functionality to the e-mail client 224, the electronic calendar 226 and/or the digital video recorder 228 as described with respect to the e-mail client 124, the electronic calendar 126 and/or the digital video recorder 128, as described with respect to FIG. 2, above.

Alternatively, the steganographic information may be combined with an analysis to provide a fingerprint wave signal and/or an embedded code or watermark in the advertisement to provide easier identification of the advertisement and enhanced functionality. The steganographic information may include the associated information or other information that may be utilized to confirm the identity of the advertisement when compared in the advertisement host.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An apparatus for recording and identifying an advertisement comprising:
a recording device for recording at least a segment of an advertisement from a broadcast source to form a recorded audio segment, the advertisement relating to a subject selected from the group consisting of a good, a service, an event, or a combination thereof;
an identification module wherein the identification module identifies the advertisement based on the recorded audio segment; and
an electronic module for receiving a communication relating to the subject of the advertisement, wherein the electronic module is selected from the group consisting of an e-mail client, an electronic calendar and a digital video recorder.

2. The apparatus of claim 1 wherein the recording device is associated with a portable electronic device.

3. The apparatus of claim 1 wherein the identification module identifies the advertisement by having the recorded audio segment compared to advertisements in a advertisement database.

4. The apparatus of claim 1 wherein the identification module reads an embedded code in the recorded audio segment to identify the advertisement.

5. The apparatus of claim 1 wherein the communication comprises information about the subject of the advertisement.

6. The apparatus of claim 1 wherein the communication creates an entry on the electronic calendar containing information about the subject of the advertisement.

7. The apparatus of claim 1 wherein the subject of the advertisement relates to a televised event and further wherein the communication sets the digital video recorder to record the televised event.

8. A system for recording and identifying an advertisement comprising:
an apparatus comprising a recording device for recording at least a segment of an advertisement from a broadcast source to form a recorded audio segment, the advertisement relating to a subject selected from the group consisting of a good, a service, an event, or a combination thereof;
an identification module wherein the identification module identifies the advertisement based on the recorded audio segment; and
an electronic module for receiving a communication relating to the subject of the advertisement, wherein the electronic module is selected from the group consisting of an e-mail client, an electronic calendar and a digital video recorder; and
a database comprising information relating to a plurality of advertisements, wherein the recorded advertisement from the broadcast source is identified by searching the database for identification characteristics of the plurality of advertisements.

9. The system of claim 8 wherein the recording device is associated with a portable electronic device.

10. The system of claim 8 wherein the recorded advertisement from the broadcast source is identified by comparing the recorded audio segment against the plurality of advertisements in the database.

11. The system of claim 8 wherein the database contains identification codes for a plurality of advertisements and further wherein the recorded audio segment of the advertisement contains an embedded code, wherein the advertisement is identified by comparing the embedded code against the identification codes for the plurality of advertisements.

12. The system of claim 8 wherein the communication comprises information about the subject of the advertisement.

13. The system of claim 8 wherein the communication creates an entry on the electronic calendar containing information about the subject of the advertisement.

14. The system of claim 8 wherein the subject of the advertisement relates to a televised event and further wherein the communication sets the digital video recorder to record the televised event.

15. A method of recording and identifying an advertisement comprising the steps of:
recording at least a segment of an advertisement from a broadcast source to form a recorded audio segment, the advertisement relating to a subject selected from the group consisting of a good, a service, an event, or a combination thereof;
identifying the advertisement based on the recorded audio segment of the advertisement; and
receiving a communication relating to the subject of the advertisement, wherein the communication is received by an electronic module, the electronic module selected from the group consisting of an e-mail client, an electronic calendar, and a digital video recorder.

16. The method of claim 15 wherein the recording device is associated with a portable electronic device.

17. The method of claim 15 further comprising the steps of:
providing a database containing a plurality of advertisements; and
identifying the advertisement by comparing the recorded audio segment to the plurality of advertisements in the database.

18. The method of claim 15 further comprising the steps of:
reading an embedded code in the recorded audio segment; and
providing a database comprising a plurality of identification codes related to a plurality of advertisements; and
identifying the recorded advertisement by comparing the embedded code against the plurality of identification codes contained in the database.

19. The method of claim 15 further comprising the step of:
creating an entry on the electronic calendar containing information about the subject of the advertisement.

20. The method of claim 15 wherein the subject of the advertisement relates to a televised event and further wherein the method comprises the step of:
setting the digital video recorder to record the televised event.
